(19) United States
(12) Patent Application Publication
(10) Pub. No.: US 2022/0326527 A1
(43) Pub. Date: Oct. 13, 2022

(54) Display System Optimization

(71) Applicant: Facebook Technologies, LLC, Menlo Park, CA (US)

(72) Inventors: Morgyn Taylor, Blackhawk, CA (US); Zahid Hossain, Woodinville, WA (US); Larry Seiler, Redmond, WA (US); Michael Yee, Woodinville, WA (US); Nilanjan Goswami, Livermore, CA (US)

(21) Appl. No.: 17/716,289

(22) Filed: Apr. 8, 2022

Related U.S. Application Data
(60) Provisional application No. 63/173,945, filed on Apr. 12, 2021.
(60) Provisional application No. 63/173,946, filed on Apr. 12, 2021.
(60) Provisional application No. 63/174,455, filed on Apr. 13, 2021.
(60) Provisional application No. 63/208,121, filed on Jun. 8, 2021.

(51) Int. Cl. G02B 27/01; G02B 27/00; G06F 3/01; G06T 19/00

(52) U.S. Cl. CPC G02B 27/0172; G02B 27/0093; G06F 3/012; G06F 3/017; G06T 19/006

(57) ABSTRACT

In one embodiment, a computing system may receive one or more signals from one or more sensors associated with an artificial reality system. The system may determine one or more parameters associated a display content for the artificial reality system based on the one or more signals of the one or more sensors associated with the artificial reality system. The system may generate the display content based on the one or more parameters. The system may output the display content to a display of the artificial reality system.

### PRIORITY

This application claims the benefit under 35 U.S.C. § 119(e) of U.S. Provisional Patent Application No. 63/173,945, filed 12 Apr. 2021, U.S. Provisional Patent Application No. 63/173,946, filed 12 Apr. 2021, U.S. Provisional Patent Application No. 63/208,121, filed 8 Jun. 2021, U.S. Provisional Patent Application No. 63/174,455, filed 13 Apr. 2021, which are incorporated herein by reference.

### TECHNICAL FIELD

This disclosure generally relates to virtual reality, augmented reality, or mixed reality.

### BRIEF DESCRIPTION OF THE DRAWINGS

FIG. 1 illustrates an example artificial reality system and user.

FIG. 2 illustrates an example augmented reality system.

FIG. 3 illustrates examples comparing a graphics-generation timeline without beam racing to timelines using beam racing.

FIG. 4 illustrates an example method for generating video frames for an AR/VR display using beam racing.

FIG. 5 illustrates another example method 4400 for generating video frames for an AR/VR display using six degrees of freedom (6DoF) rolling display correction.

FIG. 6 illustrates an example method for generating video frames for an AR/VR display using beam racing with sub-display frame rendering and eye/SLAM updates.

FIG. 7 illustrates an example method for selecting tiled regions of a visual display based on use and modifying outputs to degraded LEDs.

FIG. 8 illustrates an example surface with SDF value associated with each of the texels comprising the surface.

FIG. 9 illustrates an example surface with an alpha value associated with each of the texels comprising the surface.

FIG. 10 illustrates an example method for generating an output image that includes a surface generated using a signed distance value.

FIG. 11 illustrates a system diagram for a display engine.

FIG. 12 illustrates an example network environment associated with a social-networking system.

FIG. 13 illustrates an example computer system.

### DESCRIPTION OF EXAMPLE EMBODIMENTS

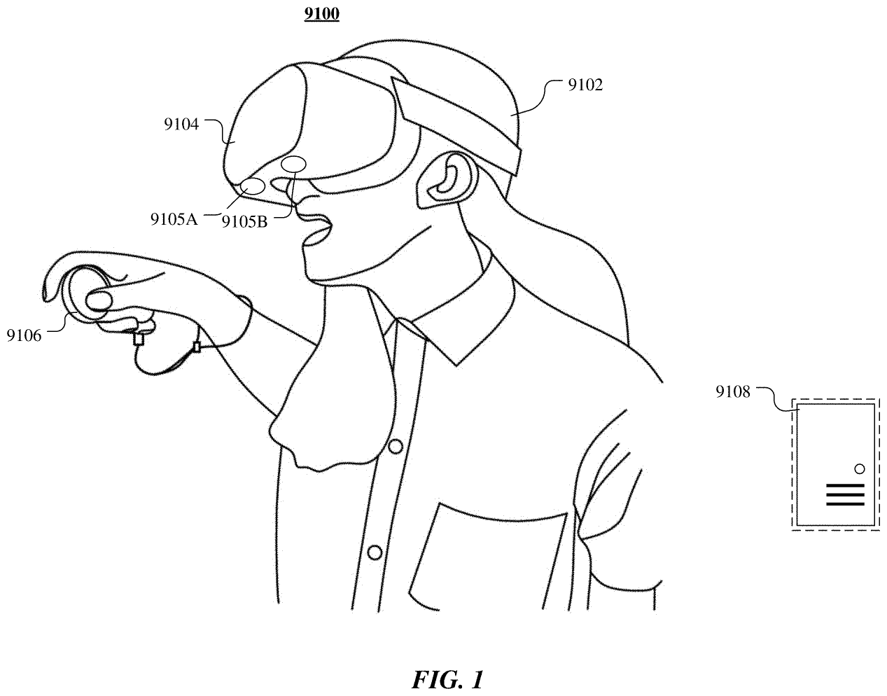

FIG. 1 illustrates an example artificial reality system 9100 and user 9102. In particular embodiments, the artificial reality system 9100 may comprise a headset 9104, a controller 9106, and a computing system 9108. A user 9102 may wear the headset 9104 that may display visual artificial reality content to the user 9102. The headset 9104 may include an audio device that may provide audio artificial reality content to the user 9102. The headset 9104 may include an eye tracking system to determine a vergence distance of the user 9102. A vergence distance may be a distance from the user's eyes to objects (e.g., real-world objects or virtual objects in a virtual space) upon which the user's eyes are converged. The headset 9104 may be referred to as a head-mounted display (HMD). One or more controllers 9106 may be paired with the artificial reality system 9100. In particular embodiments, one or more controllers 9106 may be equipped with at least one inertial measurement units (IMUs) and infrared (IR) light emitting diodes (LEDs) for the artificial reality system 9100 to estimate a pose of the controller and/or to track a location of the controller, such that the user 9102 may perform certain functions via the controller 9106. In particular embodiments the one or more controllers 9106 may be equipped with one or more trackable markers distributed to be tracked by the computing system 9108. The one or more controllers 9106 may comprise a trackpad and one or more buttons. The one or more controllers 4106 may receive inputs from the user 9102 and relay the inputs to the computing system 9108. The one or more controllers 9106 may also provide haptic feedback to the user 9102. The computing system 9108 may be connected to the headset 9104 and the one or more controllers 9106 through cables or wireless connections. The one or more controllers 9106 may include a combination of hardware, software, and/or firmware not explicitly shown herein so as not to obscure other aspects of the disclosure.

The artificial reality system 9100 may further include a computing system 9108. The computer unit may be a stand-alone unit that is physically separate from the HMD or it may be integrated with the HMD. In embodiments where the computing system 9108 is a separate unit, it may be communicatively coupled to the HMD via a wireless or wired link. The computing system 9108 may be a high-performance device, such as a desktop or laptop, or a resource-limited device, such as a mobile phone. A high-performance device may have a dedicated GPU and a high-capacity or constant power source. A resource-limited device, on the other hand, may not have a GPU and may have limited battery capacity. As such, the algorithms that could be practically used by an artificial reality system 9100 depends on the capabilities of its computing system 9108.

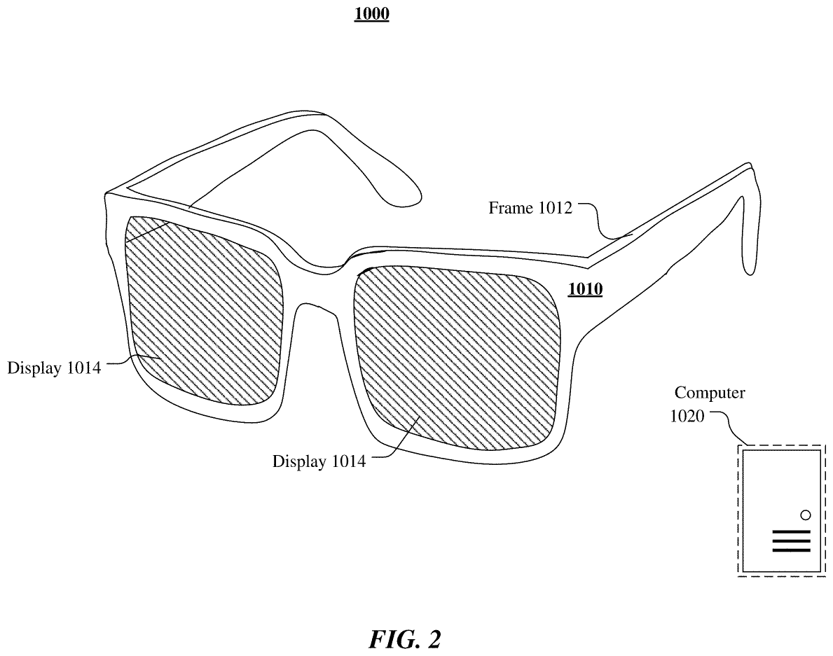

FIG. 2 illustrates an example augmented reality system 1000. The augmented reality system 1000 may include an augmented reality head-mounted display (AR HMD) 1010 (e.g., glasses) comprising a frame 1012, one or more displays 1014, and a computing system 1020. The displays 1014 may be transparent or translucent allowing a user wearing the AR HMD 1010 to look through the displays 1014 to see the real world and displaying visual artificial reality content to the user at the same time. The AR HMD 1010 may include an audio device that may provide audio artificial reality content to users. The AR HMD 1010 may include one or more cameras which can capture images and videos of environments. The AR HMD 1010 may include an eye tracking system to track the vergence movement of the user wearing the AR HMD 1010. Except as where specified throughout this application, the use of “HMD” can be used to refer to either HMD 1004 (which may occlude the user's view of the real environment) or AR HMD 1010 (which may permit the user to see the real world and displaying visual artificial reality content to the user at the same time).

The augmented reality system 1000 may further include a controller comprising a trackpad and one or more buttons. The controller may receive inputs from users and relay the inputs to the computing system 1020. The controller may also provide haptic feedback to users. The computing system 1020 may be connected to the AR HMD 1010 and the controller through cables or wireless connections. The computing system 1020 may control the AR HMD 1010 and the controller to provide the augmented reality content to and receive inputs from users. The computing system 1020 may be a standalone host computer system, an on-board computer system integrated with the AR HMD 1010, a mobile device, or any other hardware platform capable of providing artificial reality content to and receiving inputs from users.

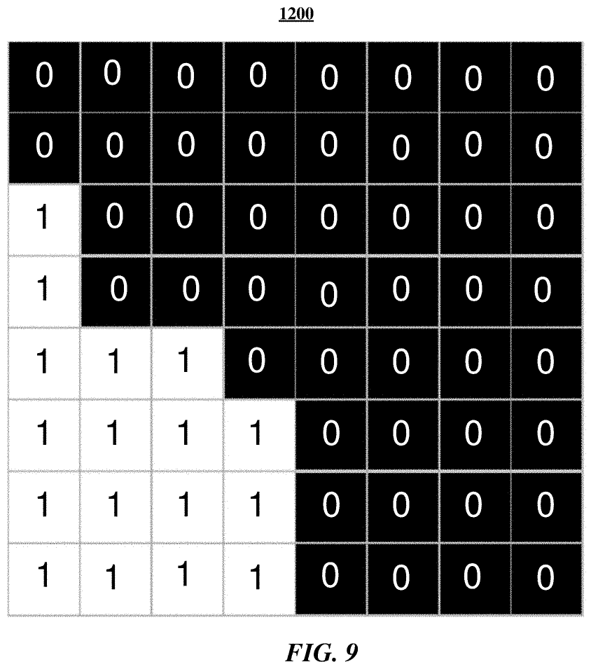

The HMD may have external-facing cameras, such as the two forward-facing cameras 9105A and 9105B shown in FIG. 9. While only two forward-facing cameras 4105A-B are shown, the HMD may have any number of cameras facing any direction (e.g., an upward-facing camera to capture the ceiling or room lighting, a downward-facing camera to capture a portion of the user's face and/or body, a backward-facing camera to capture a portion of what's behind the user, and/or an internal camera for capturing the user's eye gaze for eye-tracking purposes). The external-facing cameras 9105A and 9105B are configured to capture the physical environment around the user and may do so continuously to generate a sequence of frames (e.g., as a video).

In particular embodiments, the pose (e.g., position and orientation) of the HMD within the environment may be needed. For example, in order to render an appropriate display for the user 9102 while he is moving about in a virtual or augmented reality environment, the system 9100 would need to determine his position and orientation at any moment. Based on the pose of the HMD, the system 9100 may further determine the viewpoint of either of the cameras 9105A and 4105B or either of the user's eyes. In particular embodiments, the HMD may be equipped with inertial-measurement units (“IMU”). The data generated by the IMU, along with the stereo imagery captured by the external-facing cameras 9105A-B, allow the system 9100 to compute the pose of the HMD using, for example, SLAM (simultaneous localization and mapping) or other suitable techniques.

Traditional three-dimensional artificial reality environment reconstruction techniques and algorithms may integrate depth information about the real environment gradually over time to create a 3D representation (e.g., voxel grid, point cloud, or mesh) of the world, which can be used to re-render the environment as the user perspective changes. However, these methods are inherently too slow for certain applications, for example augmented reality applications that must quickly respond to changes in a user's pose or objects in the environment that result in rapidly changing viewpoints. For example, users may suddenly move their heads around when viewing a scene and the rendered image may need to respond immediately to the changed perspective by adjusting the view of one or more virtual representations presented to the user. Moreover, traditional artificial reality environment reconstruction techniques and algorithms may require expensive computing resources that limit the ability to recreate the artificial reality environment using components that are compact enough to be housed within an HMD, especially an AR HMD with a small form factor.

One solution to the problems involves generating and resampling “surfaces.” A surface may be one or more primitives rendered by display engine, such as quadrilaterals or contours, defined in 3D space, that have corresponding textures generated based on the mainframe rendered by the application. In particular embodiments one or more surfaces may represent a particular view of an objects within the artificial reality environment, where a surface corresponds to one or more objects that are expected to move/translate, skew, scale, distort, or otherwise change in appearance together, as one unit, as a result of a change in perspective. This method may allow for an efficient shortcut for adjusting a view in response to head movements of the user and/or one or more movements of the objects, and may significantly reduce the processing power that is required by rendering at a lower frame rate (e.g., 60 Hz, or once every 1/60th of a second) and using the surfaces to adjust or interpolate the view to account for rapid movements by the user, thus ensuring that the view is updated quickly enough to sufficiently reduce latency. This may further result in conservation of computing resources, which may be important for AR systems that utilize less-powerful components that are compact enough to be housed within an HMD, especially an AR HMD with a small form factor. Alternatively, the computing system may be capable of rendering the surfaces at a rate that matches the display rate of the HMD (e.g., 4200 Hz, once every 1/4200th of a second). This prevents the user from perceiving latency and to thereby avoid or sufficiently reduce sensory dissonance. Methods for generating and modifying representations of objects in an augmented-reality or virtual reality environment are disclosed in U.S. patent application Ser. No. 16/4586,4590, filed 27 Sep. 2019, which is incorporated by reference.

These two-dimensional surfaces may be used to represent one or more virtual or physical objects in the artificial reality environment as they would appear to a user from a particular viewpoint, and as such, may account for the user's perspective of the one or more objects from the viewpoint at a particular time. A two-dimensional occlusion surface's texture data may be made up of one or more subparts, referred to herein as “texels.” These texels may be blocks (e.g., rectangular blocks) that come together to create a texel array that makes up a two-dimensional occlusion surface. As an example and not by way of limitation, they may be contiguous blocks that make up a surface. For illustrative purposes, a texel of a surface may be conceptualized as being analogous to a pixel of an image. A two-dimensional occlusion surface may be generated by any suitable device. In particular embodiments, the surface may encode for visual information (RGBA) (e.g., as a texture) for one or more of its texels. The alpha component may be a value that specifies a level of transparency that is to be accorded to a texel. As an example and not by way of limitation, an alpha value of 0 may indicate that a texel is fully transparent, an alpha value of 1 may indicate that a texel is opaque, and alpha values in between may indicate a transparency level that is in between (the exact transparency level being determined by the value). A two-dimensional surface could represent virtual objects or physical objects. A surface representing a virtual object could be a snapshot of the virtual object as viewed from a particular viewpoint. A surface representing a physical object could be used as an occlusion surface for determining whether any virtual object or surface representing the virtual object is occluded by the physical object. If an opaque occlusion surface is in front of a surface representing a virtual object, the pixels at which the opaque occlusion surface appears would be turned off to allow the user to see through the display. The end effect is that the user would see the physical object through the display, rather than the virtual object behind the physical object.

A two-dimensional occlusion surface may support any suitable image format. To conserve resources, the two-dimensional occlusion surface may be transmitted as an alpha-mask that represents the occlusion and blending (e.g., transparency) of each pixel in the segmentation mask. The alpha-mask may be a low resolution texture (64×64 pixel), which reduces power consumption, provides for fuzzy (but aesthetically pleasing) borders when overlaid on an occluding object of interest 4210, reduces latency due to smaller resolution, and provides for better scalability.

An occlusion surface could be generated based on sensor measurements of the real-world environment. For example, depth measurements could be used to generate voxels with occupancy values or a 3D mesh. However, simply generating surfaces by projecting the occupied voxels or vertices of triangles of a three-dimensional model of the real environment onto an image plane associated with a viewpoint and rasterizing the pixels to determine if each pixel is part of an object or not may result in aliasing artifacts or edges in the surface when the occlusion surface is viewed from different angles. Additionally, unless the surface is generated at a high resolution, magnifying (e.g., zooming in on) an edge of a surface may result in a aliased, jagged line that is displeasing to the user. As such, it may be more visually appealing to the user to represent the contour of the edge or border of each physical object represented in the surface as anti-aliased, fuzzy boundaries. However, it is often computationally expensive to generate a fuzzy anti-aliasing region at the edges of a surface that can be utilized for transitional blending.

One such technique to obtain aesthetically pleasing surfaces while conserving computing resources is to generate an occlusion surface using a signed distance field (SDF) and subsequently use the SDF information to provide transparency information (Alpha) (e.g., as a texture) for one or more of its texels. This technique permits magnification without noticeable curvature or distortion of the edge or boundary. Generating a surface representing the view of an artificial reality environment using this method permits for aesthetic modifications in smooth edges or borders of each physical object represented in a surface to be displayed to the user of an artificial reality system without the computational costs associated with traditional techniques. This results in an improved smoothness and aesthetics of the generated artificial reality environment when compared to a traditional surface that may result in jagged, aliased edges. In addition, the method described herein allows the boundaries of the occlusion mask encoded within an occlusion surface to be adjusted (e.g., the occlusion mask could be made slightly larger than where the physical object appears in the surface plane). The alpha values of the boundaries may also be adjusted to provide an outward fading effect.

At a high level, a surface is generated by utilizing a depth map of the environment, which permits the computing system to determine a distance from a particular coordinate in a real environment to the edge of a particular surface. Based on these distances, the computing system may generate SDF values for each of the texels, which may then be used to generate visual information (e.g., alpha values) for each of the texels in an array, which effectively achieves generating a fuzzy, smoothed blend region at the edges or borders of the surface without sacrificing significant computing resources. This anti-aliased edge may provide a realistic and more immersive experience when applied to surfaces that are displayed to a user of an artificial reality environment.

In particular embodiments, a computing system associated with an artificial reality system may receive one or more depth measurements of a real environment. In particular embodiments, the one or more depth measurements may be determined based on sensor or image data (e.g., images captured by one or more cameras worn by the user that is connected to a head-mounted display, LIDAR, pre-generated stored depth maps of a real environment, etc.). In particular embodiments the depth measurements may be sparse depth measurements. Using this image or sensor data, the computing system may detect one or more physical objects (e.g., a table, chair, etc.) in the real world.

The computing system may further generate a three-dimensional depth map, point cloud, or similar volume representing the real environment based on the one or more depth measurements. In particular embodiments the depth map may be a three-dimensional grid space (with each cubic volume of the grid being a predetermined size, e.g., 5 cm×5 cm×5 cm). The number of observed depth measurements encapsulated within each cell of the depth map reflects the likelihood of that cell being occupied by a physical object. Each cell coordinate in the depth map may include distance information, for example an SDF value, based on the depth measurements of the real environment. As an example and not by way of limitation, each coordinate in the depth map may comprise a distance from the closest occupied cell in the depth map. In particular embodiments the data for each coordinate may comprise a distance to the closest physical object in the real environment from a particular coordinate in the depth map. In particular embodiments this depth map may be generated based on known or stored properties of the real environment, without the need for receiving images of the real environment. For example, the user may store information related to a particular room, such that the computing system can access a pre-stored depth map of a particular environment. In particular embodiments, the computing system may further generate a 3D mesh of the environment based on the depth map or point cloud. Although this disclosure describes certain techniques for generating or accessing a depth map or point cloud of a real-environment, it should be appreciated that any suitable techniques for determining depth measurements utilizing image data or sensor data from an artificial reality system can be utilized.

In particular embodiments, the computing system may continuously update the depth map as the user moves throughout the real environment. For example, the computing system may continuously receive image data or sensor data that indicates that the current depth map is inaccurate or outdated, due to for example the relocation of one or more physical objects in the real environment since the depth map was generated or last updated.

In particular embodiments the computing system may generate an occlusion surface based on the three-dimensional depth map and representing a current viewpoint of a user of the artificial reality environment. A surface may be a two-dimensional surface generated by the computing system using sensor data or image data captured by one or more cameras or sensors associated with the artificial reality system (e.g., a received image captured by the one or more cameras at a particular time). A “viewpoint” of an artificial reality environment may refer to a user perspective of the artificial reality environment, which may, for example, be determined based on a current position and orientation of an HMD. A surface's texture data may be made up of one or more subparts, referred to herein as “texels.” These texels may be blocks (e.g., rectangular blocks) that come together to create a texel array that makes up a surface. As an example and not by way of limitation, they may be contiguous blocks that make up a surface. For illustrative purposes, a texel of a surface may be conceptualized as being analogous to a pixel of an image. A surface may be generated by any suitable device. In particular embodiments, the surface may encode for information for one or more of its texels.

Particular embodiments described herein supports a technique that is termed “beam racing.” In the graphics rendering pipeline, each primitive is rendered in memory before the scene is rasterized. In other words, pixels in the final scene are generate one by one after objects in the scene have been rendered. The pixels are displayed together and assumed to represent the scene at a particular instant in time. However, since it takes time to generate the pixels, there may be significant time lag (e.g., 11 milliseconds) between the time when objects are rendered and the time when the pixels are displayed. In conventional display contexts (e.g., movies, animation, etc.), the lag may not be noticeable. This is not the case in the VR/AR context, however. In VR/AR, a user expects immediate feedback between movement and visual perception. For example, as the user turns his head, he expects the scene to change at that instant and the current display to reflect his current point of view. Any delays, such the time tag for generating and outputting pixels after rendering, may negatively affect the user experience. For example, if at time to the user is standing up, the system may begin to render a scene based on the elevated perspective of the user. However, by the time the pixels of the scene are output at time to +11 ms, the user may be sitting down. Since the user is now expecting to see a scene from a lower vantage point, seeing a scene that does not reflect such expectation would negatively affect the VR experience and may even cause dizziness or nausea.

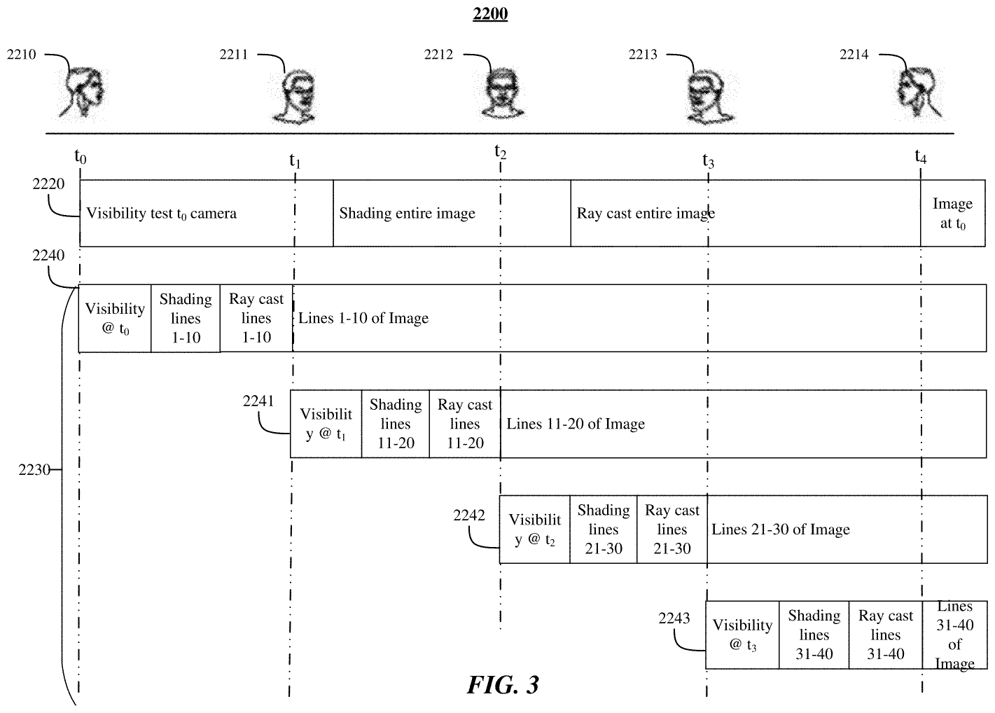

FIG. 3 illustrates examples comparing a graphics-generation timeline 2200 without using beam racing to timelines using beach racing. In particular, FIG. 3 illustrates a graphics generation pipeline 2220 that generates and outputs an entire image at the same time. In the illustrated example, a user wearing an AR/VR device may be rotating his head quickly from position 2210 at time to a position 2214 at time t4 (through a series of positions including 2211, 2212, 2213). If the pipeline 2220 is configured to generate an entire image, it may begin by configuring the orientation of the virtual camera based on the head position 2210 of the user at time to and proceed with shading and ray casting the entire image. By the time the image is ready to be output, the time may be t4. However, at time t4, the user's head position 2214 may have changed significantly from the time to position 2210, yet the image that is presented to the user may have been based on the user's head position 2210 at to. This lag may cause a sense of disorientation for the user.

Particular embodiments reduce the latency between rendering and image display by outputting pixels scan line by scan line, where each line is generated based on renderings made when it is that line's turn to be output. For example, the system may render at time to and ray cast line 0 (rather than the whole scene) based on the to rendering; render at time ti and ray cast line 1 based on the ti rendering; and so on. Since the system is only processing one line at a time (or multiple predetermined lines at a time but not the all the lines together), the delay between render time and pixel-output time becomes much shorter, and the renderings would be based on the latest movement/perspective of the user. As a result, real-time scene changes would be much more reactive. This “beam racing” technique has the potential to significantly reduce the head-movement to photon latency. Even significant batching, such as hundreds of lines (hundreds of thousands of pixels) could provide large multiplicative reductions in latency over waiting for the full frame before scan-out. In particular embodiments, the system may schedule rendering and ray casting tasks with respect to the scan-out clock.

Referring again to FIG. 3, the beam racing graphics pipeline 2220 shows an example of the beam racing technique. In this example, each video frame displayed has 40 horizontal lines. The first timeline 2240 represents the timing of generating the first 10 lines (lines 1 to 10) of the video frame. At time to, the system may use latest motion sensory data available at that time (e.g., from a VR device's inertial measurement unit, gyroscope, etc.) to orient the virtual camera and perform visibility tests. The system may then perform shading and ray casting lines 1-10 of the video frame. In the example shown, lines 1-10 are ready by time ti and displayed to the user. Since the system is only tasked with generating 10 lines rather than all 40 lines, the duration needed for generating lines 1-10 (e.g., ti−to) is significantly shorter than the duration needed for generating the whole image (e.g., t4−to), as shown by pipeline 2220. Thus, at time ti, the user would be presented with lines 1-10 that were generated using the latest sensor information from to, which is much more current than the scenario shown by pipeline 2220. In particular embodiments, lines 1-10 may be on continuous display until the rest of the lines in the video frame have been generated, and the process would repeat to generate updated lines 1-10 based on the virtual camera's updated orientation/position. Other timelines 2230 may include the timelines of 2240, 2241, 2242, and 2243.

In particular embodiments, after the system generates lines 1-10, it may proceed to generate lines 11-20, as represented by timeline 2241. The process may begin at time ti, at which time the system may perform visibility tests based on the latest sensor data available at that time. The system may again go through the process of shading and ray casting, and then output lines 11-20 at time t2. Thus, at time t2, the user is presented with lines 11-20 that are generated based on sensory data from time ti. The system may then repeat the process to generate lines 21-30 using the timeline 2242, starting from time t2 and ending at time t3, and then generate lines 31-40 using the timeline 2243, starting from time t3 and ending at time t4. Thus, at time t4, the user is presented with a video frame that includes much more current information (e.g., as early as time t3), compared to the scenario presented by the pipeline 2220, where the user at time t4 is presented with a frame generated based on to data.

In particular embodiments, the rendering system may further predict a user's head position/orientation (head pose) to output scenes that match a user's expectations. For example, if the user is in the process of turning, the system may predict that the user would continue to turn in the next frame and begin rendering a scene based on the predicted camera position/orientation. If the latency is 1 ms, the system would have to predict farther ahead, which his more difficult and likely more erroneous. If the latency is significantly reduced (e.g., to 1 ms), the system would only need to predict 1 ms ahead. This makes the prediction task much easier and less error-prone.

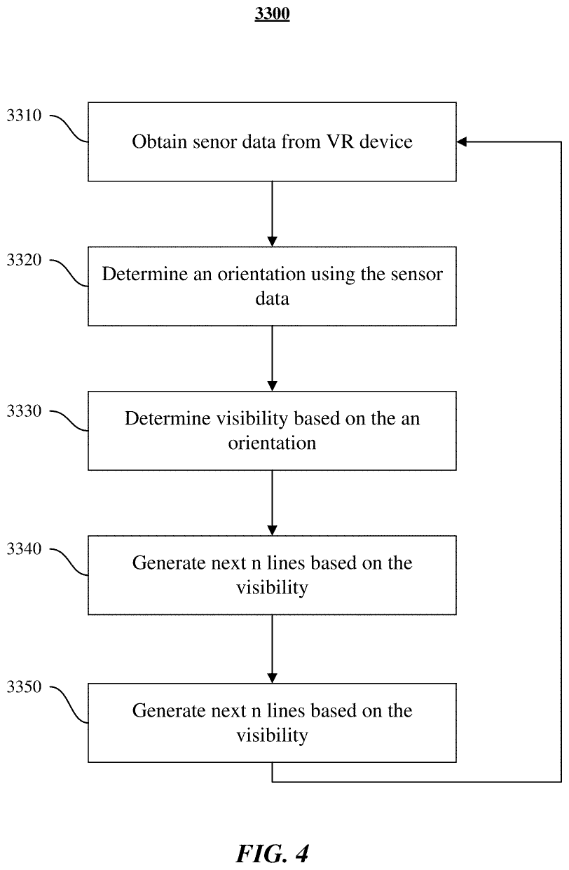

In particular embodiments, the on-board compute unit of an AR/VR headset may receive image assets (e.g., patches or surfaces of images) from a separate compute unit (e.g., a mobile phone, laptop, or any other type of compute unit). The separate compute unit may render the image assets from the perspective of the user's predicted head pose at the time when the first display lines are scanned out. The image assets may then be transmitted to the AR/VR headset. The AR/VR headset is tasked with re-rendering or reprojecting the received image assets onto more up-to-date predictions of the user's head pose for each block of scan lines. FIGS. 3 and 4 show two embodiments for doing so.

FIG. 4 illustrates an example method 3300 for generating video frames for an AR/VR display using beam racing. The method may begin at step 3310, where a computing system may obtain sensor data generated by an artificial reality (AR) or a virtual reality (VR) device at, for example, time t0. The AR/VR device, for example, may include a head mounted display and one or more motion sensors, such as an inertial measurement unit, gyroscope, accelerometer, etc. At step 3320, the system may use the sensor data to predict a first head pose in a three-dimensional (3D) space at the time when the next n lines are displayed. The predicted head pose could have 6 degrees-of-freedom or 3 degrees-of-freedom. For example, based on the acceleration and/or rotational data from a gyroscope and the last known orientation of the user in the 3D space, the system may compute a predicted head pose of the user when the next n lines are displayed. In particular embodiments, the user's pose may be represented in the 3D space by orienting/positioning a virtual camera in the 3D space.

At step 3330, the system may determine a visibility of one or more objects (e.g., the image assets obtained from the separate compute unit) defined within the 3D space by projecting rays based on the predicted head pose to test for intersection with the one or more objects. For example, based on the orientation of the virtual camera in 3D space, the system may project rays into the 3D space to test for intersections with any object that is defined therein. In particular embodiments, the direction of the rays may be based on a focal surface map (or multiple focal surface maps, one per primary color), as described herein. The density of the rays may also be defined by the focal surface map or a separate importance map, as described herein.

At step 3340, the system may generate n lines (e.g., 1, 3, 5, 10, 1100 lines, etc.) of pixels based on the determined visibility of the one or more objects. In particular embodiments, the generation of the pixels may be the result of shading and rasterization processes. The n number of lines that is generated may be a subset of the total lines of pixels in the AR/VR display. Continuing the example from above, if the AR/VR display has a total of 40 lines, at this stage the system may generate line 1-10 of the display. In other words, the number of lines generated may be a subset of the total number of lines.

At step 3350, the system may output the n generated lines of pixels for display by the AR/VR device. As previously described, rather than updating all the lines of the display based on the same virtual camera orientation, the system in particular embodiments may only update a subset, such as lines 1-10.

In particular embodiments, the process of generating and outputting a subset of lines may then be repeated for the next subset of lines. For example, at step 3310, the system may obtain the latest sensor data from the AR/VR device (e.g., the sensor data associated with time ti). At step 3320, the system may again predict a second head pose of the user in the 3D space at the time when the next subset of lines are displayed. At step 3330, the system may then proceed to determine a visibility of any objects defined within the 3D space by projected rays based on the second head pose to test for intersection with the objects. At step 3340, the system may generate another n lines of pixels (e.g., lines 11-20) based on the determined second visibility of the one or more objects. At step 3350, the system may output the n lines of pixels for display by the virtual reality device. As shown in FIG. 3, by the end of the timelines 2240 and 2241, the lines 11-20 is displayed concurrently with the lines 1-10.

The steps illustrated in FIG. 4 may repeat until all the lines of the display are generated and outputted. Each n lines of pixels may be considered as a subset of the total lines of pixels of the display, and each set of n lines may be sequentially and iteratively generated. For example, if the total number of lines is 40, the system may generate, in order, lines 1-10, 11-20, 21-30, and 31-40, and the process may thereafter repeat, starting against from the first set of lines (e.g., lines 1-10). So once a first set of n lines associated with time to is output, the set of lines may remain unchanged until after each of the other lines of the display is generated (using sensor data generated by the AR/VR device after to). Once it is again the first set of lines' turn to be generated, the first set of lines may be replaced by lines of pixels generated based on the latest sensor data.

In FIG. 4, the process shows that the step of determining the second orientation is performed after the outputting of the one or more first lines of pixels (e.g., the lines of pixels generated based on the orientation associated with time to). In particular embodiments, a multi-threaded or multi-processor computing system may begin the process of generating the next set of n lines of pixels before the previous set of n lines of pixels is output. For example, if lines 11-20 are generated based on sensor data from time ti, time ti may be any time while the system is processing steps 1320-1350 for the previous set of lines 1-10.

In particular embodiments, the number of lines generated per iteration may be equal to a predetermined number. For example, n may be preset to be 1, 5, 10, 20, etc. In particular embodiments, the graphics system may predefine this number. Alternatively or additionally, the graphics system may allow an application to specify the number of lines that should be generated per iteration. For example, an application requesting the graphics system to generate a scene may specify the number of lines that it wishes to generate per iteration. The application may communicate this information to the graphics system through an API, for example.

Particular embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates an example method for generating video frames for a AR/VR display using beam racing, including the particular steps of the method of FIG. 4, this disclosure contemplates any suitable method for doing so, including any suitable steps, which may include all, some, or none of the steps of the method of FIG. 4, where appropriate. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

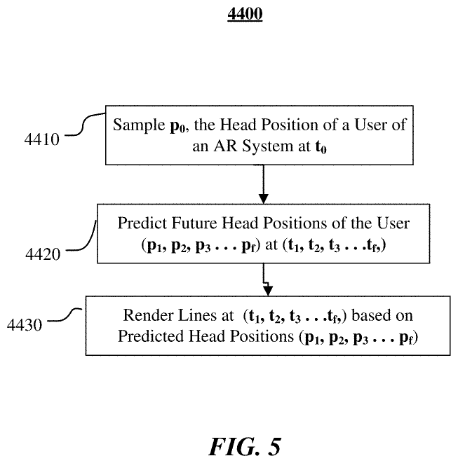

FIG. 5 illustrates another example method 4400 for generating video frames for an AR/VR display using six degrees of freedom (6DoF) rolling display correction. For AR/VR systems with 6DoF control input, it may be particularly important to account for user head position in order to prevent disrupting a user's immersion in augmented reality. User immersion is sustained, in part, by minimizing the lag and mismatch between the user's actual viewpoint and the perspective from which the output image is rendered. Example method 4400 may enhance user immersion by rendering lines of a rolling display based on input comprising more accurate estimations of a user's head position than would be available in a state-of-the-art rendering technique.

At step 4410 of FIG. 5, in an embodiment, a user's predicted head position (p₀) is associated with a start time t₀, which could correspond to the estimated time at which the first line of the AR/VR display is scanned out. A user's 6DoF head position may be sampled in a variety of ways, including using any suitable motion prediction model and sensor data available before to.

At step 4420 of FIG. 5, in an embodiment, a user's head position may be predicted for times t₁, t₂, t₃ . . . t_{f} for corresponding sets of lines of the AR/VR display, where t_{f} is a predicted time when a final set of lines for the current frame will be displayed, and t₁, t₂, t₃ . . . are predicted future times when preceding sets of lines will be displayed to the user. Predicted head positions p₁, p₂, p₃ . . . p_{f} respectively associated with times t₁, t₂, t₃ . . . t_{f}, may be generated by a variety of methods, including interpolation. A user's head position p_{f} may first be predicted at t_{f} based on its current position and current or predicted rates of change along 6DoF. The head positions p₁, p₂, p₃ . . . between p₀ and p_{f} may be estimated by interpolation. For example, if a user's head is 12.0 inches from the origin along one axis of a 6DoF system at to and it is predicted to be 6.0 inches from the origin along that axis at t_{f}, then the user's head may be predicted to be 9.0 inches from the origin along that axis at time ((t₀+t_{f})÷2). Using interpolation helps ensure that the predicted head poses are smooth. It is appreciable by one of ordinary skill in the art that a variety of techniques are available for generating such intermediate predictions, including techniques that account for predicted velocity or predicted acceleration of the user's head in 6DoF space.

At step 4430 of FIG. 5, in an embodiment, lines are rendered for display at times t₁, t₂, t₃ . . . t_{f} based, in part, on predicted head positions p₁, p₂, p₃ . . . p_{f}. These renderings may be more “accurate,” or of a higher quality, than those renderings that would have been produced had p₀, the user's head position at t₀, been used to facilitate rendering for the entire period from t₀ to t_{f}. Further, it may be advantageous to interpolate head positions in this manner, rather than to interpolate images, because interpolating images might introduce substantial blur effects or other artifacts into a displayed image.

Particular embodiments described herein supports a technique that is termed “beam racing.” In the graphics rendering pipeline, each primitive is rendered in memory before the scene is rasterized. In other words, pixels in the final scene are generate one by one after objects in the scene have been rendered. The pixels are displayed together and assumed to represent the scene at a particular instant in time. However, since it takes time to generate the pixels, there may be significant time lag (e.g., 11 milliseconds) between the time when objects are rendered and the time when the pixels are displayed. In conventional display contexts (e.g., movies, animation, etc.), the lag may not be noticeable. This is not the case in the VR/AR context, however. In VR/AR, a user expects immediate feedback between movement and visual perception. For example, as the user turns his head, he expects the scene to change at that instant and the current display to reflect his current point of view. Any delays, such the time tag for generating and outputting pixels after rendering, may negatively affect the user experience. For example, if at time to the user is standing up, the system may begin to render a scene based on the elevated perspective of the user. However, by the time the pixels of the scene are output at time to +11 ms, the user may be sitting down. Since the user is now expecting to see a scene from a lower vantage point, seeing a scene that does not reflect such expectation would negatively affect the VR experience and may even cause dizziness or nausea.

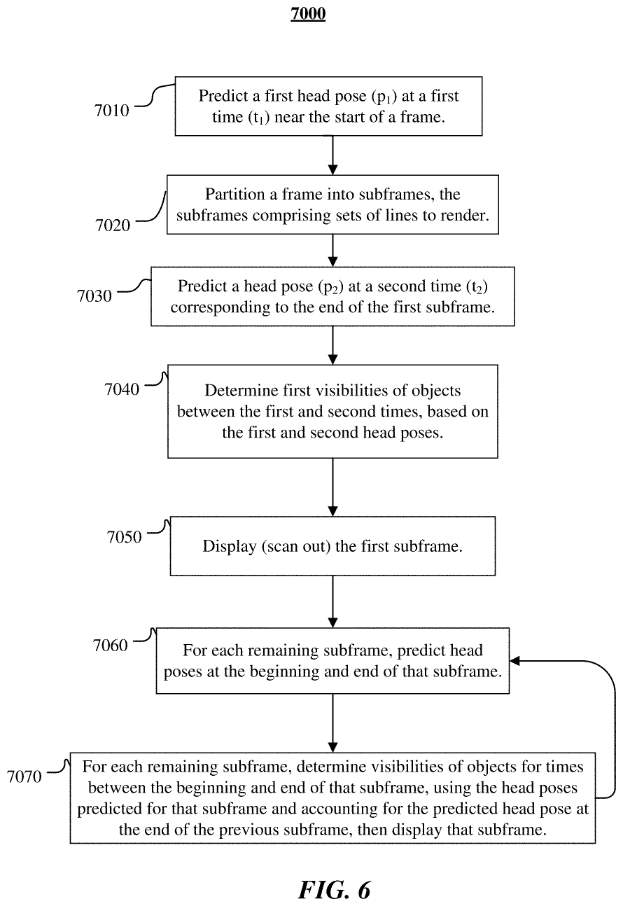

FIG. 6 illustrates an example method 7000 for generating video frames for an AR/VR display using beam racing with sub-display frame rendering and eye/SLAM updates. In an embodiment, the frame is partitioned into two or more subframes, each subframe comprising sets of lines of pixels to be rendered and displayed to the user. In an embodiment, the frame is partitioned into two subframes of approximately equal size. In other embodiments, the frame is partitioned into a plurality of subframes which may or may not be of similar sizes (each subframe may or may not have similar numbers of lines of pixels).

At step 7010 of FIG. 6, in an embodiment, a user's predicted head pose (p₁) is associated with a start time ti, which could correspond to the estimated time at which the first line of a frame will be scanned out by an AR/VR display. A user's 6DoF head position may be sampled in a variety of ways, including using any suitable motion prediction model and current sensor data available before t₁. At step 7020, and throughout method 7000, in an embodiment, a user's current and predicted eye positions may be accounted for using suitable methods, including by SLAM (also called vSLAM).

At step 7030 of FIG. 6, in an embodiment, a user's head pose (p₂) may be predicted for time t₂ which may correspond to a time when a final line of the first subframe will be scanned out by the AR/VR device. t₂ may be associated with the end of the first subframe. A user's 6DoF head position may be sampled in a variety of ways, including using any suitable motion prediction model and current sensor data available before t₁. Thus, before rendering the subframe, the AR/VR device predicts the head poses p₁ and p₂ using currently available sensor data.

At step 7040 of FIG. 6, in an embodiment, the system may determine first visibilities of objects between the first and second times, based on the first and second predicted head poses. For example, each row of pixels within the first subframe has an associated display time t′ that falls between t₁ and t₂. The predicted head pose p′ at time t′ could be estimated based on head poses p₁ and p₂. In an embodiment, step 7040 comprises predicting intermediate head poses between p₁ and p₂, where each intermediate head pose is used to render one or more rows of pixels within the first subframe. Such head poses p′ at time t′ may be predicted by a variety of methods, including interpolation. For example, if a user's head is 12.0 inches from the origin along one axis of a 6DoF system at ti and it is predicted to be 6.0 inches from the origin along that axis at t₂, then the user's head may be predicted to be 9.0 inches from the origin along that axis at time ((t₁+t₂)÷2). This predicted intermediate head pose prediction may be used to render portions of the subframe (e.g., rows of pixels) that would be output at time ((t₁+t₂)÷2). In a similar manner, intermediate head poses associated with other times between ti and t2 may be computed and used to render the corresponding rows of pixels. It is appreciable by one of ordinary skill in the art that a variety of techniques are available for generating such intermediate predictions, including techniques that account for predicted velocity or predicted acceleration of the user's head in 6DoF space and techniques which account for a user's eyes (using SLAM).

At step 7050 of FIG. 6, in an embodiment, the first subframe, comprising a first set of lines of pixels, is scanned out by an AR/VR display. In other embodiments, the first subframe may be stored in a display buffer until the rest of the subframes of the frame are rendered and ready to be scanned out by the AR/VR display.

At step 7060 of FIG. 6, in an embodiment, method 2400 continues by predicting head poses at the beginning and end of the next subframe. The newly predicted head poses are generated based on the most current information available (e.g., sensor data). For example, in particular embodiments, the beginning and end head poses for the second subframe may both be predicted based on the most current sensor data available. In other embodiments, the beginning head pose of the second subframe may be the end head pose of the first subframe, and the end head pose of the second subframe may be predicted based on the most current sensor data available. Using the end head pose of the previous subframe as the beginning head pose of the current subframe helps ensure smoothness between subframes.

At step 7070 of FIG. 6, in an embodiment, visibilities are determined for objects at times between the beginning and end of the current subframe, for example, in a manner previously discussed in this disclosure. At step 7070, in an embodiment, however, the previously predicted head pose at the end of the previous subframe is reused for rendering at the start of the current subframe in order to make the displayed motion smooth. Otherwise, there could be a perceived jump between subframes from a user perspective. After calculating visibilities, the system may then display the current subframe comprising sets of lines of pixels scanned in an AR/VR display or store the current subframe in a display buffer until all subframes within the frame have been rendered.

According to FIG. 6, in an embodiment where the frame comprises more than two subframes, method 7000 continues on from step 7070 back to step 7060 where head poses are then predicted for the next subframe. According to FIG. 6, in an embodiment, method 7000 would then proceed to step 7070 where visibilities are determined and the subframe is displayed. According to FIG. 6, in an embodiment, method 7000 may continue in this manner until there are no more subframes left to be displayed to the user for the current frame.

Modern LED visual displays are comprised of a large number of LEDs. The LEDs within the display may degrade at different rates because as previously mentioned, LEDs degrade based on usage. Depending on the type and usage of the visual display, certain regions of the display may experience greater usage compared to other regions. For example, a particular visual display, among other things, may contain a tool bar at one of the borders and display video content towards the center of the display. On this particular visual display, LED usage in displaying the tool bar may be different compared to LED usage in displaying video content. Therefore, the aforementioned LEDs may degrade at various rates because of their potentially different usage.

Since degraded LEDs become less bright, the performance of the visual display will decline unless the visual display system makes adjustments. In order to increase the brightness of degraded LEDs, the visual display system may increase electrical inputs such as the intensity of current or pulse width supplied to the LEDs. Since visual display systems, if programmed properly, have the ability to compensate for degraded LEDs within their display, designers of LED visual display systems may be interested in understanding comparative LED degradation within the various regions of their visual display. The visual display system may be able to automatically provide adjustments in electrical outputs to degraded LEDs in order to prevent significant decreases in performance of the visual display.

Through research and development, designers may observe how much a particular type of LED will degrade over time and much electrical inputs need to be adjusted in order to compensate for the degraded output. Once developers understand how much electrical inputs need to be adjusted to, they can accurately program the visual display system to accurately compensate for LED degradation and avoid declines in performance of the visual display. Therefore, accurately measuring and/or predicting the amount of LED usage across the entire regions of the visual display is critical to design accurate compensation mechanisms.

The challenge of measuring or predicting LED usage may be exacerbated when applied to certain types of visual display systems where regions of LEDs within the display may experience vastly different usage rates compared to other regions. For example, a visual display system in the form of a wearable heads up display, such as but not limited to wearable augmented reality glasses, may be a particularly challenging system. Within such a display, for example, at a particular time, the majority of LEDs within the display may not be in use as the user is simply looking through the display at the real world. In such instances, only peripheral regions of the display projecting a menu bar may be in use whereas LEDs within the center regions of the display may not be in use. But, at another point in time, the user may be viewing world-locked content that could appear anywhere within the display, depending on the orientation of the user. Such visual displays with varied usage rates across regions within the display may be contrasted with displays such as a smart phone screen, where usage is more constant as the entire screen is often actively displaying an object or image.

While it is possible to measure the performance of every single LED within a display, doing so is not efficient in terms of both cost effectiveness and data consumption. A solution is to subsample the visual display and measure usage for a plurality of tiled regions of LEDs within the display. A tiled region is a small section of LEDs on a visual display (e.g., 16×16 pixels, 32×32 pixels, etc.). The benefits of only sampling the greyscale for tiled regions of a display rather than the entire display, may include but are not limited to, power and data usage savings while still being able to estimate LED degradation.

In order to measure LED greyscale, there needs to be one or more sensors that can measure the brightness of the display. Each sensor may be located in front of the display, which is from the direction a user will view the display, behind the display opposite from the side a user will view the display, or embedded within the display. The one or more sensors may measure the current and pulse-width modulation supplied to the tiled regions to determine the brightness of the selected tiled regions within the visual display. The measured brightness of the sampled tiled regions can, overtime, represent a usage pattern of portions of the display. To estimate a usage pattern of the entire display, the display system could match the measured usage pattern against pre-determined usage patterns (or heat maps) of the whole display (e.g., the manufacturer could measure a variety of usage patterns before shipping the system to the end users). The pre-determined usage pattern that best matches the measured usage patterns at the selected tiled regions could be used to estimate the LED's degradation based on known characteristics of the display. From there, the display system may use the LED degradation profile corresponding to the pre-determined usage pattern to compensate for the degraded LEDs. This may be done by applying per-pixel scaling factors to compensate for the degraded LEDs. A key step in this invention is to choose effective tiled regions of LEDs within the display for sampling. The tiled regions may be fixed or preferably may be relocated within the display based on user activity.

In one embodiment, the plurality of tiled regions to be sampled may be preselected and fixed during the production of the visual display system. In this embodiment, the sampled tiled regions may not be moved, so the sensor will record the brightness output form the same regions of the visual display for the entire life of the display.

In another embodiment, there may be a plurality of preselected tiled regions for sampling, but one or all of the tiled regions may be manually relocated within the visual display. For example, if the user feels that they are frequently using a certain region of the visual display, the user may decide to place sampled tiled regions within that certain region of the display. In another embodiment, the regions sampled could be random.

In a preferred embodiment, the locations of the tiled regions may be automatically relocated by the visual display system based on the usage. The system's goal may be to select tiled regions that are most frequently used by the display system. This would be advantageous because as previously mentioned, the most used LEDs within the display will experience the most degradation and the system will have to compensate the current intensity or pulse width sent to those LEDs to avoid performance decreases of the visual display. For example and not by way of limitation, when the visual display system is a wearable augmented reality glasses, if the user engages in activity where the center of the visual display is mostly utilized such as when watching a video, the visual display system may selected a plurality of tiled regions to sample which are located more toward the center of the visual display. When a user engages in such activity, the display system may recognize that the user is utilizing a head locked usage pattern since the displayed object is locked to a fixed position relative to the visual display. Whenever the display system is utilized for head locked display, the system may select a certain plurality of tiled regions for brightness sampling.

For example and not by way of limitation, when the visual display system is a wearable augmented reality glasses, if the user engages in activity where more peripheral regions of the visual display may be utilized, such as playing an augmented reality game where objects or characters may appear as if in the real world, the visual display system may select a plurality of tiled regions to sample which are located more toward the periphery of the display. When a user engages in such activity, the display system may recognize that the user is utilizing a world locked usage pattern since the displayed object is located to a fixed position relative to the real world and not the visual display. In a world locked scenario, when a user moves their display, the object or image will move relative to the display because it is fixed in location relative to the world. Whenever the display system is utilized for world locked display, the system may select a certain plurality of tiled regions for brightness sampling.

For example and not by way of limitation, the location of the plurality of tiled regions for sampling may be adjusted by the display system based on the user preferences or options elected by the user. One such situation may occur when, for example, the user decides to move the location of a visible menu bar within the display. When this occurs, the system may decide to sample one or more tiled regions within the menu bar, which would be useful since the menu bar will cause the same LEDs to be used repeatedly which will cause degradation.

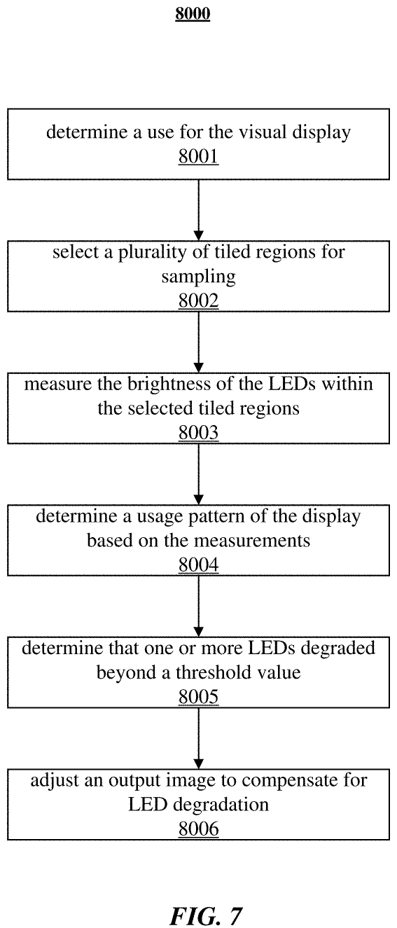

FIG. 7 illustrates an example method 8000 for selecting tiled regions of a visual display based on use and modifying outputs to degraded LEDs. The method may begin at step 8001, where a user determines a use for the visual display. The user may decide to use the visual display for a multitude of purposes. Such uses may include but are not limited to uses where items or objects may be displayed within the visual display utilizing head locked or world locked positioning. At step 8002, the visual display system computer selects a plurality of tiled regions for sampling. In particular embodiments, the new tiled regions may be selected based on the use of the visual display. Based on usage, the system computer may select tiled regions which might be more frequently used. For example and not by way of limitation, if the system determines that the user is utilizing a head locked pattern of usage, the system may select tiled regions towards the center of the display since the center will used more often. In another example and not by way of limitation, if the system computer determines the user is utilizing a world locked pattern of usage, the system computer may select tiled regions that are evenly distributed throughout the display. In another example and not by way of limitation, if the user moves the location of a visible menu bar within the display, the system computer may select tiled regions within the menu bar for sampling. In another embodiment, the selected sampling regions may be fixed or randomized.

At step 8003, one or more sensors are used to measure the brightness or greyscale of the LEDs within the tiled regions. The measurements may be performed based on the electrical current and pulse-width modulation used to illuminate the LEDs. The measurements may be aggregated over time. At step 8004, the system computer determines a usage pattern of the display based on the measurements made. For example, the system computer may determine a user pattern for the whole display by matching the measurements of the selected tiled regions to pre-determined usage patterns of the whole display. At step 8005, the system computer may determine that one or more LEDs degraded beyond a threshold value. For example, the usage pattern of the display may correspond to an estimated degradation pattern of the LEDs. If the degradation is not yet significant, the system computer would not need to compensate for it. However, if the degradation is significant (e.g., an LED degraded beyond a threshold value), then the system computer would compensate for the degradation using step 8006 below. The threshold value may be any amount of degradation. For example and not by way of limitation, the computer may only identify LEDs have degraded to the point where their output is below 75% of their expected and non-degraded greyscale output. At step 8006, the system computer adjusts an output image to compensate for LED degradation. For example, given an output image to be displayed by the LEDs, the system computer may adjust the grayscale of the pixels according to the estimated degradation pattern of the display (e.g., for LEDs that have degraded, the corresponding image pixels that would be displayed by those LEDs may be scaled to be brighter). The adjusted pixel values, in turn, would cause electrical outputs to be adjusted for the degraded LEDs (electrical adjustments may include but are not limited to electrical current and pulse width). Particular embodiments may repeat one or more steps of the method of FIG. 7, where appropriate.

Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for selecting tiled regions of a visual display based on use and modifying outputs to degraded LEDs including the particular steps of the method of FIG. 7, this disclosure contemplates any suitable method for selecting tiled regions of a visual display based on use and modifying outputs to degraded LEDs including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

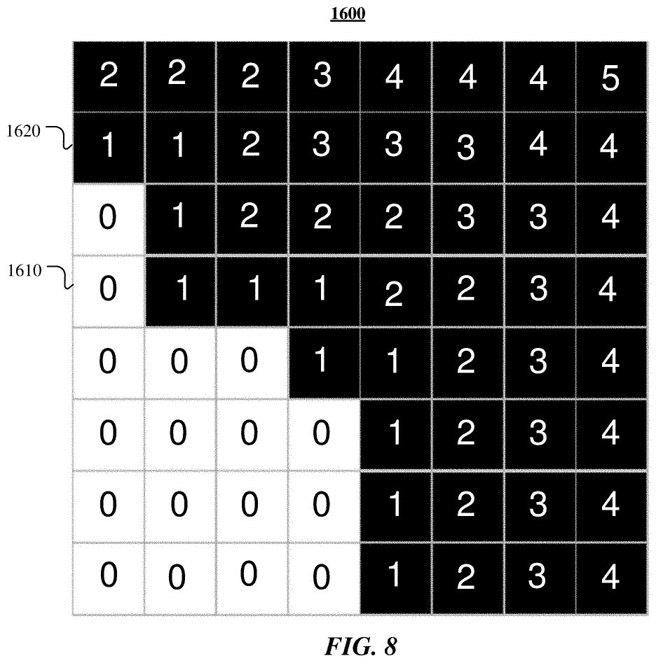

In particular embodiments the computing system may generate occlusion surfaces by projecting the depth map (e.g., a voxel grid with SDF values) of physical objects onto an image plane associated with a particular viewpoint of the user. The projection could be rasterized to generate the SDF values of the texels in the occlusion surfaces. FIG. 8 illustrates an example surface 1600 with SDF value associated with each of the texels comprising the surface. The SDF component may be a value that specifies a distance from a texel to the edge of a particular object in the real environment that is depicted in the surface. As an example and not by way of limitation, a texel value of 0 may indicate that an occupied texel 1610 on surface 1600 is where an object in the real environment would appear in the image plane of the occlusion surface as seen from a particular viewpoint, a texel value of 1 may indicate that an unoccupied texel 1620 on surface 1600 corresponding to empty space is a distance of 1 texel from the edge of the closest occupied texel, 2 may indicate that an unoccupied texel is a distance of 2 texels from the edge of the closest occupied texel, etc. In particular embodiments the computing system may generate the SDF value by accessing the depth map of the real environment associated with a viewpoint and determining the distance of each texel to a particular object as perceived from the viewpoint.

In particular embodiments the computing system may utilize a ray-casting or other rendering process for sampling the surfaces (including occlusion surfaces and surfaces that represent virtual objects) to determine the final pixels values. In particular embodiments, a computing system (e.g., a laptop, a cellphone, a desktop, a wearable device) may perform this first ray-casting process to sample the virtual-object surfaces and occlusion surfaces. This use of the ray-casting process may be referred to herein as a “visibility test,” because it may be used to determine a visibility of virtual-object surfaces and occlusion surfaces as observed from a particular viewpoint. The computing system may cast a ray from the viewpoint toward each pixel in the imaginary image screen and determine the intersection between the ray and surfaces positioned in the 3D space. The point of intersection within an occlusion surface (e.g., surface 1600 shown in FIG. 8) is surrounded by several texels (e.g., 1610). The texels closest to the point of intersection (e.g., the four closest texels) may be identified, and the SDFs of those texels could be interpolated to generate an interpolated SDF value for the pixel. The interpolated SDF value could be used to determine whether the portion of the occlusion surface appearing at the pixel is occupied by a physical object or not. For example, an interpolated SDF value of 0 may indicate that a portion of a physical object appears at the pixel, and an interpolated SDF value of greater than 0 may indicate that no physical object appears at the pixel.

In particular embodiments the computing system may utilize the sampled SDF values in order to generate an alpha value for each pixel. FIG. 9 illustrates an example pixel array 1200 with an alpha value associated with each of the pixels. The alpha value may represent the level of transparency that is to be accorded to a particular pixels. As an example and not by way of limitation, an alpha value of 0 may indicate that a texel is fully transparent, an alpha value of 1 may indicate that a texel is opaque, and alpha values in between may indicate a transparency level that is in between (the exact transparency level being determined by the value). These alpha values may represent the occlusion and blending (e.g., transparency) of each pixel in the occlusion mask.

In particular embodiments the computing system may achieve different blending effects using different transform functions (e.g., the SDF may be scaled and/or offset) to map interpolated SDF values into corresponding alpha values. As an example, the computing system may adjust the alpha value of every pixel with a SDF value between 0 and 1 (SDFs greater than 1 would be deemed to have a “transparent” alpha value). If an alpha value is either 0 (totally transparent) or 1 (totally opaque), the SDF could be rounded up or down based on a threshold rounding value of 0.5 SDF (e.g., a SDF value of 0.6 would be rounded up to SDF 1, which would translate to alpha 0 or totally transparent). This adjustment may provide for a smooth anti-alias edge that is 1 pixel wide. The computing system may adjust the size of this anti-aliased edge by altering the predetermined distance from the edge for which texels are adjusted. For example, to add a buffer around the alpha mask, an offset could be applied to the SDF values (e.g., subtracting a SDF value by 3 would effectively extend the alpha mask by 3 pixels outward to include pixels that wouldn't otherwise be deemed opaque). As another example, the computing system may adjust the alpha value of every texel that is located within 16 pixels of the edge of the object. This will result in a wider, “fuzzier” edge on the surface. For example, if an alpha value could be any value between 0 and 1, the SDF values could be scaled to create the desired blurring effect (e.g., SDF values between 0 and 16 could be scaled to be within alpha 0 and 1).

The resulting pixels, which includes alpha values for each pixel and is generated based on the corresponding interpolated SDF values sampled from the texels of the occlusion surface, offers aesthetic benefits and computational benefits over traditional methods. Computationally, the disclosed methods permit for generating surfaces without having to project vertices of triangles of a three-dimensional model of the real environment onto an image plane associated with a viewpoint and rasterizing the pixels to determine if each texel in the surface is part of an object or not. Aesthetically, the surface retains straight edges of objects, even when the image is magnified or zoomed in on for display. With traditional techniques, if the edge of an object is curved and the surface is over-magnified (e.g., the zoom exceeds a certain threshold), the curved edges will begin to appear polygamized. With the disclosed methods, because SDF is used to represent that the contours of the surface, the edges will be smoother and only appear polygamized once individual pixels have been magnified to be multi-pixels in size. The disclosed methods thus permit using significantly smaller array data because the surface can be significantly more magnified without a loss in image quality.

In particular embodiments the components of the device that generated the surface may also sample the surface to generate the SDF values and alpha values for the one or more texels comprising the surface. As another example and not by way of limitation, an onboard computing system of an HMD may sample the one or more surfaces and generate the SDF values and alpha values after it receives the surface generated from a separate computing system (e.g., from a CPU or GPU of a wearable, handheld, or laptop device). In particular embodiments, there may be a predefined maximum number of surfaces that may be generated for a view (e.g., 16 surfaces) for efficiency purposes. Although this disclosure focuses on displaying an output image to a user on an AR HMD, it contemplates displaying the output image to a user on a VR display or any other suitable device.

In particular embodiments, a surface may be positioned and oriented in a coordinate system in three-dimensional space. In particular embodiments the coordinate system may correspond to the real environment, for example known world-locked coordinates (x, y). The world-coordinates of the surface may be based on an absolute coordinate in the artificial reality environment (e.g., at a particular x, y coordinate), or the world-coordinates of the surface may be determined relative to the pose of the HMD, the HMD, the user, a particular point on the user (e.g., an eyeball of the user), or one or more other surfaces or virtual objects in the artificial reality (e.g., posed at a coordinate relative to a wall or virtual coffee table in the artificial reality environment). The depth of a surface permits the computing system to position the surface in the artificial reality environment relative to, for example and not by way of limitation, one or more other real objects or virtual object representations in the environment. In particular embodiments the virtual object representations may be two-dimensional surfaces as viewed from the viewpoint of the user.

In particular embodiments, a computing system may generate an output image of a viewpoint of a scene of an artificial reality environment for display to a user that may include for example, one or more surfaces as described herein. Generating the output image may be done on the GPU of the computing system by rendering a surface as viewed from user's current viewpoint for display. As an example and not by way of limitation, this output image of a viewpoint may include a set of virtual objects. The output image may comprise a set of image pixels that correspond to the portion of the surface that is determined to be visible from a current viewpoint of the user. The output image may be configured to cause a display to turn off a set of corresponding display pixels such that the visible portion of the object are visible to the user when the generated output image is displayed to the user. In particular embodiments the output image may be transmitted to the HMD for display. This allows for an immersive artificial reality environment to be displayed to the user.

The output image may correspond to a viewpoint of the user based on the relative occlusions of the surfaces relative to one or more virtual objects or real objects in the artificial reality environment. The computing system may utilize a ray-casting or other rendering process, such as ray tracing, for determining visual information and location information of one or more virtual objects that are to be displayed within the initial output image of a viewpoint of a scene of an artificial reality environment. In particular embodiments, the first computing system (e.g., a laptop, a cellphone, a desktop, a wearable device) may perform this first ray-casting process to generate an output image of a viewpoint of an artificial reality environment. A “viewpoint” of an artificial reality environment may refer to a user perspective of the artificial reality environment, which may, for example, be determined based on a current position and orientation of an HMD. This use of the ray-casting process may be referred to herein as a “visibility test,” because it may be used to determine a visibility of a virtual object relative to a real object in the real environment by comparing a model of the virtual object with the SDF surface. The ray-casting process may ultimately be used to associate pixels of the screen with points of intersection on any objects that would be visible from a particular viewpoint of an artificial reality environment.

In particular embodiments the generated output image may be rendered by one or more components (e.g., CPU, GPU, etc.) of the computing system physically connected to the HMD. However, the HMD may have limited system resources and a limited power supply, and these limitations may not be appreciably reduced without resulting in too much weight, size, and/or heat for the user's comfort. As a result, it may not be feasible for the HMD to unilaterally handle all the processing tasks involved in rendering an output image of a viewpoint of an artificial reality environment. In particular embodiments, the one or more components may be associated with a device (e.g., a laptop, a cellphone, a desktop, a wearable device) that may be used to render the output image (e.g., perform the ray-casting process). In particular embodiments, the device is in communication with a computing system on the HMD but may be otherwise physically separated from the HMD. As an example and not by way of limitation, this device may be a laptop device that is wired to the HMD or communicates wirelessly with the HMD. As another example and not by way of limitation, the device may be a wearable (e.g., a device strapped to a wrist), handheld device (e.g., a phone), or some other suitable device (e.g., a laptop, a tablet, a desktop) that is wired to the HMD or communicates wirelessly with the HMD. In particular embodiments the device may send this output image to the HMD for display.

In particular embodiments the components of the device that generated the output image may also generate the one or more surfaces. As another example and not by way of limitation, an onboard computing system of an HMD may generate the one or more SDF surfaces after it receives the output image from a separate computing system (e.g., from a CPU or GPU of a wearable, handheld, or laptop device). In particular embodiments, there may be a predefined maximum number of surfaces that may be generated for a view (e.g., 16 surfaces) for efficiency purposes. Although this disclosure focuses on displaying an output image to a user on an AR HMD, it contemplates displaying the output image to a user on a VR display or any other suitable device.

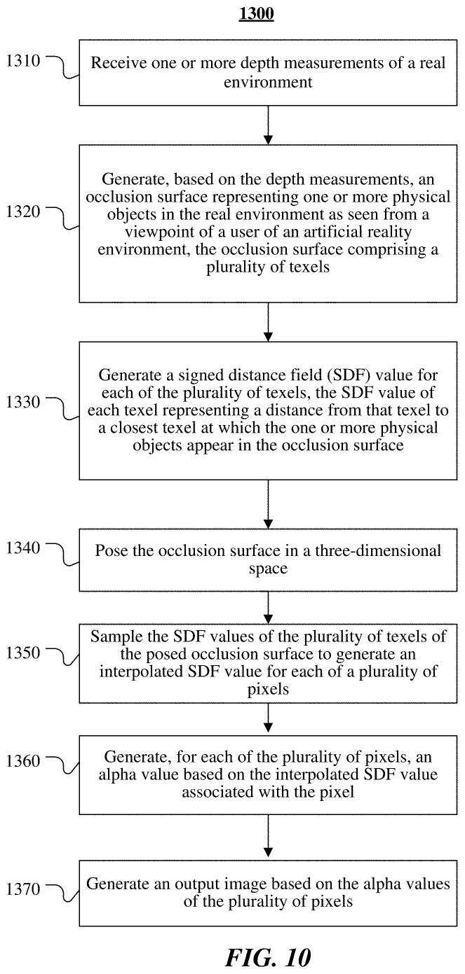

FIG. 10 illustrates an example method 1300 for generating an output image that includes a surface generated using a signed distance value. The method may begin at step 1310, where a computing system may receive one or more depth measurements of a real environment.

At step 1320, a computing system may generate, based on the depth measurements, an occlusion surface representing one or more physical objects in the real environment as seen from a viewpoint of a user of an artificial reality environment, the occlusion surface comprising a plurality of texels.

At step 1330, a computing system may generate a signed distance field (SDF) value for each of the plurality of texels, the SDF value of each texel representing a distance from that texel to a closest texel at which the one or more physical objects appear in the occlusion surface.

At step 1340, a computing system may pose the occlusion surface in a three-dimensional space.

At step 1350, a computing system may sample the SDF values of the plurality of texels of the posed occlusion surface to generate an interpolated SDF value for each of a plurality of pixels.

At step 1360, a computing system may generate, for each of the plurality of pixels, an alpha value based on the interpolated SDF value associated with the pixel.

At step 1370, a computing system may generate an output image based on the alpha values of the plurality of pixels.

In particular embodiments, a computing system may receive one or more signals from one or more sensors associated with an artificial reality system. The system may determine one or more parameters associated a display content for the artificial reality system based on the one or more signals of the one or more sensors associated with the artificial reality system. The system may generate the display content based on the one or more parameters. The system may output the display content to a display of the artificial reality system. In particular embodiments, the system may predict a first head pose of a user of the artificial reality system in a three-dimensional (3D) space at a first time, the first time corresponding to when a first set of lines of a frame is to be output by the display of the artificial reality system. The system may determine a first visibility of one or more objects defined within the 3D space based on the first head pose of the user. The system may generate the first set of lines of the frame based on the determined first visibility of the one or more objects. The system may output the first set of lines using the display of the artificial reality system. In particular embodiments, the system may predict one or more second head poses of the user of the artificial reality system in the 3D space based on the first head pose and a predicted six degrees-of-freedom (6DoF) movement of the artificial reality system at one or more subsequent times to the first time, the one or more subsequent times respectively corresponding to when one or more second sets of lines of the frame are to be output by the display. The system may determine, based on the one or more second head poses, one or more second visibilities of the one or more objects defined within the 3D space. The system may generate the one or more second sets of lines of the frame using, respectively, the one or more second visibilities of the one or more objects. The system may output, using the display of the artificial reality system, the one or more second sets of lines of the frame at the one or more subsequent times, respectively.

In particular embodiments, the system predict a first head pose of a user of the artificial reality system in a three-dimensional (3D) space at a first time, the first time corresponding to when a first line of a first set of lines of a plurality of sets of lines of a frame is to be output by a display of the artificial reality system. The system may determine a plurality of subframes that partition the frame, wherein each subframe comprises a set of lines of the plurality of sets of lines of the frame to be output by the display of the artificial reality system. The system may predict a second head pose of the user of the artificial reality system in the three-dimensional (3D) space at a second time, the second time corresponding to when a final line of the first set of lines of the plurality of sets of lines of the frame is to be output by the display of the artificial reality system. The system may determine a first plurality of visibilities of one or more objects defined within the 3D space based on the first head pose and the second head pose. The system may generate the first set of lines of the frame based on the determined first plurality of visibilities of the one or more objects, wherein the first set of lines of the frame corresponds to a first subframe of the plurality of subframes. The system may output the first set of lines using the display of the artificial reality system.

In particular embodiments, the system may predict a third head pose of the artificial reality system in the three-dimensional (3D) space at a third time, the third time corresponding to when a first line of a second set of lines of the plurality of sets of lines of the frame is to be output by the display of the artificial reality system. The system may predict a fourth head pose of the artificial reality device in the three-dimensional (3D) space at a fourth time, the fourth time corresponding to when a final line of the second set of lines of the plurality of sets of lines of the frame is to be output by the display of the artificial reality system. The system may determine a second plurality of visibilities of the one or more objects defined within the 3D space based on the second head pose, the third head pose, and the fourth head pose. The system may generate the second set of lines of the frame based on the determined second plurality of visibilities of the one or more objects, wherein the second set of lines of the frame corresponds to the second subframe of the plurality of subframes. The system may output the second set of lines using the display of the artificial reality system.

In particular embodiments, the system receive one or more depth measurements of a real environment. The system may generate, based on the depth measurements, an occlusion surface representing one or more physical objects in the real environment as seen from a viewpoint of a user of an artificial reality environment, the occlusion surface comprising a plurality of texels. The system may generate a signed distance field (SDF) value for each of the plurality of texels, the SDF value of each texel representing a distance from that texel to a closest texel at which the one or more physical objects appear in the occlusion surface. The system may pose the occlusion surface in a three-dimensional space. The system may sample the SDF values of the plurality of texels of the posed occlusion surface to generate an interpolated SDF value for each of a plurality of pixels. The system may generate, for each of the plurality of pixels, an alpha value based on the interpolated SDF value associated with the pixel. The system may generate an output image based on the alpha values of the plurality of pixels.

In particular embodiments, the system may select a plurality of tiled regions within the display for sampling. The system may measure a brightness of each light-emitting element in the plurality of tiled regions. The system may determine a usage pattern of the display based on the measured brightness of the light-emitting elements in the plurality of tiled regions. The system may adjusting, based on the usage pattern, an output image to compensate for degradations of the display.

Particular embodiments may repeat one or more steps of the method of FIG. 10, where appropriate. Although this disclosure describes and illustrates particular steps of the method of FIG. 10 as occurring in a particular order, this disclosure contemplates any suitable steps of the method of FIG. 10 occurring in any suitable order. Moreover, although this disclosure describes and illustrates an example method for generating an output image that includes a surface generated using a signed distance value including the particular steps of the method of FIG. 10, this disclosure contemplates any suitable method for generating an output image that includes a surface generated using a signed distance value including any suitable steps, which may include all, some, or none of the steps of the method of FIG. 10, where appropriate. Furthermore, although this disclosure describes and illustrates particular components, devices, or systems carrying out particular steps of the method of FIG. 10, this disclosure contemplates any suitable combination of any suitable components, devices, or systems carrying out any suitable steps of the method of FIG. 10.

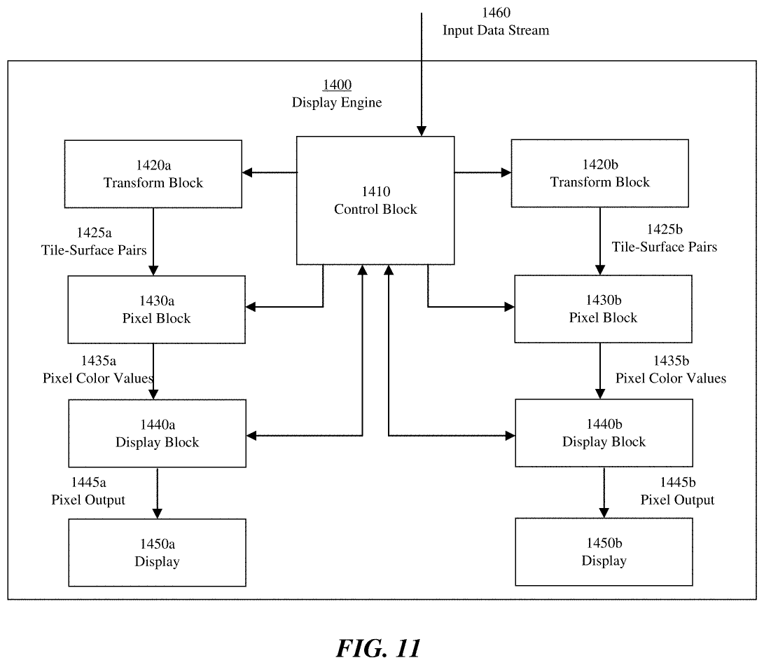

FIG. 11 illustrates a system diagram for a display engine 1400. The display engine 1400 may comprise four types of top level blocks. As shown in FIG. 11, these blocks may include a control block 1410, transform blocks 1420a and 1420b, pixel blocks 1430a and 1430b, and display blocks 1440a and 1440b. One or more of the components of the display engine 1400 may be configured to communicate via one or more high-speed bus, shared memory, or any other suitable method. As shown in FIG. 11, the control block 1410 of display engine 1400 may be configured to communicate with the transform blocks 1420a and 1420b and pixel blocks 1430a and 1430b. Display blocks 1440a and 1440b may be configured to communicate with the control block 1410. As explained in further detail herein, this communication may include data as well as control signals, interrupts and other instructions.

In particular embodiments, the control block 1410 may receive an input data stream 1460 from a primary rendering component and initialize a pipeline in the display engine 1400 to finalize the rendering for display. In particular embodiments, the input data stream 1460 may comprise data and control packets from the primary rendering component. The data and control packets may include information such as one or more surfaces comprising texture data and position data and additional rendering instructions. The control block 1410 may distribute data as needed to one or more other blocks of the display engine 1400. The control block 1410 may initiate pipeline processing for one or more frames to be displayed. In particular embodiments, a HMD may comprise multiple display engines 1400 and each may comprise its own control block 1410.

In particular embodiments, transform blocks 1420a and 1420b may determine initial visibility information for surfaces to be displayed in the view of the artificial reality environment. In general, transform blocks (e.g., the transform blocks 1420a and 1420b) may cast rays from pixel locations on the screen and produce filter commands (e.g., filtering based on bilinear or other types of interpolation techniques) to send to pixel blocks 1430a and 1430b. Transform blocks 1420a and 1420b may perform ray casting from the current viewpoint of the user (e.g., determined using inertial measurement units, eye trackers, and/or any suitable tracking/localization algorithms, such as simultaneous localization and mapping (SLAM)) into the artificial scene where surfaces are positioned and may produce results to send to the respective pixel blocks (1430a and 1430b).

In general, transform blocks 1420a and 1420b may each comprise a four-stage pipeline, in accordance with particular embodiments. The stages of a transform block may proceed as follows. A ray caster may issue ray bundles corresponding to arrays of one or more aligned pixels, referred to as tiles (e.g., each tile may include 16×16 aligned pixels). The ray bundles may be warped, before entering the artificial reality environment, according to one or more distortion meshes. The distortion meshes may be configured to correct geometric distortion effects stemming from, at least, the displays 1450a and 1450b of the HMD. Transform blocks 1420a and 1420b may determine whether each ray bundle intersects with surfaces in the artificial reality environment by comparing a bounding box of each tile to bounding boxes for each surface. If a ray bundle does not intersect with an object, it may be discarded. Tile-surface intersections are detected, and corresponding tile-surface pair 1425a and 1425b are passed to pixel blocks 1430a and 1430b.

In general, pixel blocks 1430a and 1430b determine color values from the tile-surface pairs 1425a and 1425b to produce pixel color values, in accordance with particular embodiments. The color values for each pixel are sampled from the texture data of surfaces received and stored by the control block 1410 (e.g., as part of input data stream 1460). Pixel blocks 1430a and 1430b receive tile-surface pairs 1425a and 1425b from transform blocks 1420a and 1420b, respectively, and schedule bilinear filtering. For each tile-surface pair 1425a and 1425b, pixel blocks 1430a and 1430b may sample color information for the pixels within the tile using color values corresponding to where the projected tile intersects the surface. In particular embodiments, pixel blocks 1430a and 1430b may process the red, green, and blue color components separately for each pixel. Pixel blocks 1430a and 1430b may then output pixel color values 1435a and 1435b, respectively, to display blocks 1440a and 1440b.

In general, display blocks 1440a and 1440b may receive pixel color values 1435a and 1435b from pixel blocks 1430a and 1430b, converts the format of the data to be more suitable for the scanline output of the display, apply one or more brightness corrections to the pixel color values 1435a and 1435b, and prepare the pixel color values 1435a and 1435b for output to the displays 1450a and 1450b. Display blocks 1440a and 1440b may convert tile-order pixel color values 1435a and 1435b generated by pixel blocks 1430a and 1430b into scanline- or row-order data, which may be required by the displays 1450a and 1450b. The brightness corrections may include any required brightness correction, gamma mapping, and dithering. Display blocks 1440a and 1440b may provide pixel output 1445a and 1445b, such as the corrected pixel color values, directly to displays 1450a and 1450b or may provide the pixel output 1445a and 1445b to a block external to the display engine 1400 in a variety of formats. For example, the HMD may comprise additional hardware or software to further customize backend color processing, to support a wider interface to the display, or to optimize display speed or fidelity.

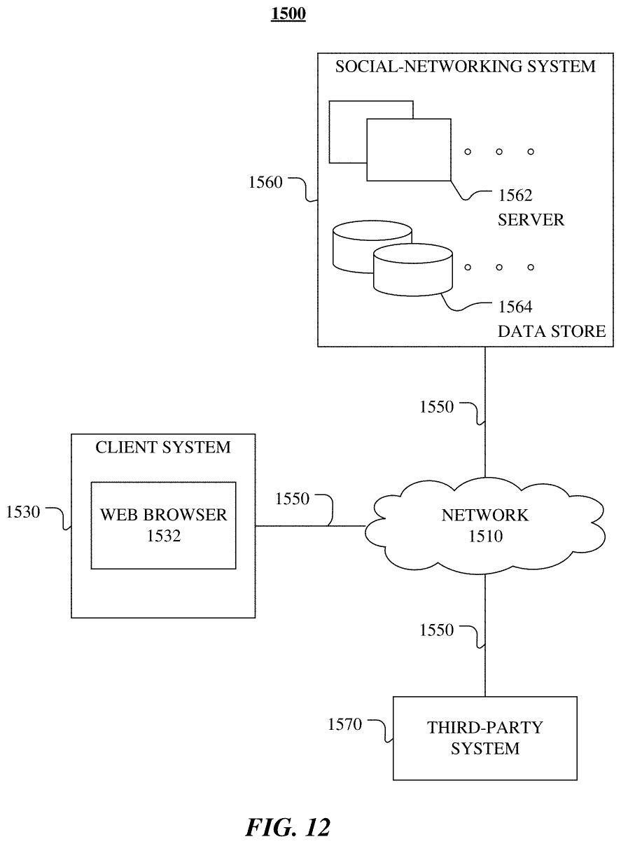

FIG. 12 illustrates an example network environment 1500 associated with a social-networking system. Network environment 1500 includes a client system 1530, a social-networking system 1560, and a third-party system 1570 connected to each other by a network 1510. Although FIG. 12 illustrates a particular arrangement of client system 1530, social-networking system 1560, third-party system 1570, and network 1510, this disclosure contemplates any suitable arrangement of client system 1530, social-networking system 1560, third-party system 1570, and network 1510. As an example and not by way of limitation, two or more of client system 1530, social-networking system 1560, and third-party system 1570 may be connected to each other directly, bypassing network 1510. As another example, two or more of client system 1530, social-networking system 1560, and third-party system 1570 may be physically or logically co-located with each other in whole or in part. Moreover, although FIG. 12 illustrates a particular number of client systems 1530, social-networking systems 1560, third-party systems 1570, and networks 1510, this disclosure contemplates any suitable number of client systems 1530, social-networking systems 1560, third-party systems 1570, and networks 1510. As an example and not by way of limitation, network environment 1500 may include multiple client system 1530, social-networking systems 1560, third-party systems 1570, and networks 1510.

This disclosure contemplates any suitable network 1510. As an example and not by way of limitation, one or more portions of network 1510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 1510 may include one or more networks 1510.

Links 1550 may connect client system 1530, social-networking system 1560, and third-party system 1570 to communication network 1510 or to each other. This disclosure contemplates any suitable links 1550. In particular embodiments, one or more links 1550 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 4650 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 1550, or a combination of two or more such links 1550. Links 1550 need not necessarily be the same throughout network environment 1500. One or more first links 1550 may differ in one or more respects from one or more second links 1550.

In particular embodiments, client system 1530 may be an electronic device including hardware, software, or embedded logic components or a combination of two or more such components and capable of carrying out the appropriate functionalities implemented or supported by client system 1530. As an example and not by way of limitation, a client system 1530 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 1530. A client system 1530 may enable a network user at client system 1530 to access network 1510. A client system 1530 may enable its user to communicate with other users at other client systems 4630.

In particular embodiments, client system 1530 may include a web browser 1532, and may have one or more add-ons, plug-ins, or other extensions. A user at client system 1530 may enter a Uniform Resource Locator (URL) or other address directing the web browser 1532 to a particular server (such as server 1562, or a server associated with a third-party system 1570), and the web browser 1532 may generate a Hyper Text Transfer Protocol (HTTP) request and communicate the HTTP request to server. The server may accept the HTTP request and communicate to client system 1530 one or more Hyper Text Markup Language (HTML) files responsive to the HTTP request. Client system 1530 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts, combinations of markup language and scripts, and the like. Herein, reference to a webpage encompasses one or more corresponding webpage files (which a browser may use to render the webpage) and vice versa, where appropriate.

In particular embodiments, social-networking system 1560 may be a network-addressable computing system that can host an online social network. Social-networking system 1560 may generate, store, receive, and send social-networking data, such as, for example, user-profile data, concept-profile data, social-graph information, or other suitable data related to the online social network. Social-networking system 1560 may be accessed by the other components of network environment 1500 either directly or via network 1510. As an example and not by way of limitation, client system 1530 may access social-networking system 1560 using a web browser 1532, or a native application associated with social-networking system 1560 (e.g., a mobile social-networking application, a messaging application, another suitable application, or any combination thereof) either directly or via network 1510. In particular embodiments, social-networking system 1560 may include one or more servers 1562. Each server 1562 may be a unitary server or a distributed server spanning multiple computers or multiple datacenters. Servers 1562 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 1562 may include hardware, software, or embedded logic components or a combination of two or more such components for carrying out the appropriate functionalities implemented or supported by server 1562. In particular embodiments, social-networking system 1560 may include one or more data stores 1564. Data stores 1564 may be used to store various types of information. In particular embodiments, the information stored in data stores 1564 may be organized according to specific data structures. In particular embodiments, each data store 1564 may be a relational, columnar, correlation, or other suitable database. Although this disclosure describes or illustrates particular types of databases, this disclosure contemplates any suitable types of databases. Particular embodiments may provide interfaces that enable a client system 1530, a social-networking system 1560, or a third-party system 1570 to manage, retrieve, modify, add, or delete, the information stored in data store 1564.

In particular embodiments, social-networking system 1560 may store one or more social graphs in one or more data stores 1564. In particular embodiments, a social graph may include multiple nodes—which may include multiple user nodes (each corresponding to a particular user) or multiple concept nodes (each corresponding to a particular concept)—and multiple edges connecting the nodes. Social-networking system 1560 may provide users of the online social network the ability to communicate and interact with other users. In particular embodiments, users may join the online social network via social-networking system 1560 and then add connections (e.g., relationships) to a number of other users of social-networking system 1560 to whom they want to be connected. Herein, the term “friend” may refer to any other user of social-networking system 1560 with whom a user has formed a connection, association, or relationship via social-networking system 1560.

In particular embodiments, social-networking system 1560 may provide users with the ability to take actions on various types of items or objects, supported by social-networking system 1560. As an example and not by way of limitation, the items and objects may include groups or social networks to which users of social-networking system 1560 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 1560 or by an external system of third-party system 1570, which is separate from social-networking system 1560 and coupled to social-networking system 1560 via a network 1510.

In particular embodiments, social-networking system 1560 may be capable of linking a variety of entities. As an example and not by way of limitation, social-networking system 1560 may enable users to interact with each other as well as receive content from third-party systems 1570 or other entities, or to allow users to interact with these entities through an application programming interfaces (API) or other communication channels.

In particular embodiments, a third-party system 1570 may include one or more types of servers, one or more data stores, one or more interfaces, including but not limited to APIs, one or more web services, one or more content sources, one or more networks, or any other suitable components, e.g., that servers may communicate with. A third-party system 1570 may be operated by a different entity from an entity operating social-networking system 1560. In particular embodiments, however, social-networking system 1560 and third-party systems 1570 may operate in conjunction with each other to provide social-networking services to users of social-networking system 1560 or third-party systems 1570. In this sense, social-networking system 1560 may provide a platform, or backbone, which other systems, such as third-party systems 1570, may use to provide social-networking services and functionality to users across the Internet.

In particular embodiments, a third-party system 1570 may include a third-party content object provider. A third-party content object provider may include one or more sources of content objects, which may be communicated to a client system 1530. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 1560 also includes user-generated content objects, which may enhance a user's interactions with social-networking system 1560. User-generated content may include anything a user can add, upload, send, or “post” to social-networking system 1560. As an example and not by way of limitation, a user communicates posts to social-networking system 1560 from a client system 1530. Posts may include data such as status updates or other textual data, location information, photos, videos, links, music or other similar data or media. Content may also be added to social-networking system 1560 by a third-party through a “communication channel,” such as a newsfeed or stream.

In particular embodiments, social-networking system 1560 may include a variety of servers, sub-systems, programs, modules, logs, and data stores. In particular embodiments, social-networking system 1560 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 1560 may also include suitable components such as network interfaces, security mechanisms, load balancers, failover servers, management-and-network-operations consoles, other suitable components, or any suitable combination thereof. In particular embodiments, social-networking system 1560 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 1560 to one or more client systems 1530 or one or more third-party system 1570 via network 1510. The web server may include a mail server or other messaging functionality for receiving and routing messages between social-networking system 1560 and one or more client systems 1530. An API-request server may allow a third-party system 1570 to access information from social-networking system 1560 by calling one or more APIs. An action logger may be used to receive communications from a web server about a user's actions on or off social-networking system 1560. In conjunction with the action log, a third-party-content-object log may be maintained of user exposures to third-party-content objects. A notification controller may provide information regarding content objects to a client system 1530. Information may be pushed to a client system 1530 as notifications, or information may be pulled from client system 1530 responsive to a request received from client system 1530. Authorization servers may be used to enforce one or more privacy settings of the users of social-networking system 1560. A privacy setting of a user determines how particular information associated with a user can be shared. The authorization server may allow users to opt in to or opt out of having their actions logged by social-networking system 1560 or shared with other systems (e.g., third-party system 1570), such as, for example, by setting appropriate privacy settings. Third-party-content-object stores may be used to store content objects received from third parties, such as a third-party system 1570. Location stores may be used for storing location information received from client systems 1530 associated with users. Advertisement-pricing modules may combine social information, the current time, location information, or other suitable information to provide relevant advertisements, in the form of notifications, to a user.

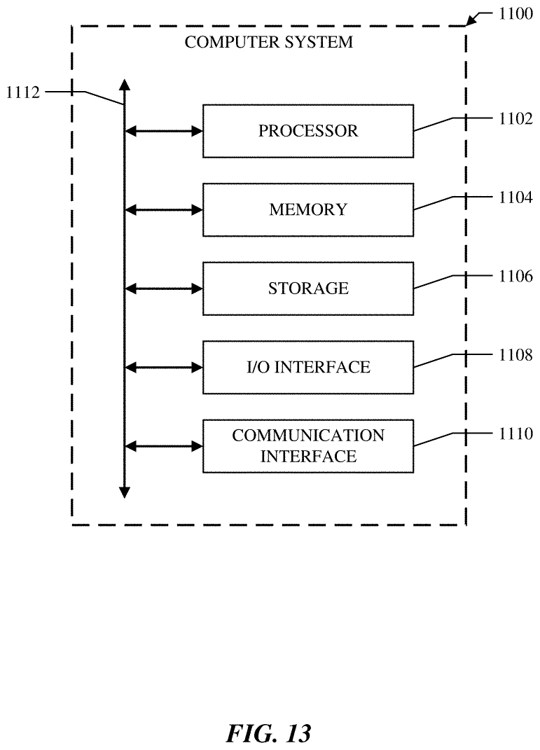

FIG. 13 illustrates an example computer system 1100. In particular embodiments, one or more computer systems 1100 perform one or more steps of one or more methods described or illustrated herein. In particular embodiments, one or more computer systems 1100 provide functionality described or illustrated herein. In particular embodiments, software running on one or more computer systems 1100 performs one or more steps of one or more methods described or illustrated herein or provides functionality described or illustrated herein. Particular embodiments include one or more portions of one or more computer systems 1100. Herein, reference to a computer system may encompass a computing device, and vice versa, where appropriate. Moreover, reference to a computer system may encompass one or more computer systems, where appropriate.

This disclosure contemplates any suitable number of computer systems 1100. This disclosure contemplates computer system 1100 taking any suitable physical form. As example and not by way of limitation, computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1100 may include one or more computer systems 1100; be unitary or distributed; span multiple locations; span multiple machines; span multiple data centers; or reside in a cloud, which may include one or more cloud components in one or more networks. Where appropriate, one or more computer systems 1100 may perform without substantial spatial or temporal limitation one or more steps of one or more methods described or illustrated herein. As an example and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

In particular embodiments, computer system 1100 includes a processor 1102, memory 1104, storage 1106, an input/output (I/O) interface 1108, a communication interface 1110, and a bus 1112. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage 1106; decode and execute them; and then write one or more results to an internal register, an internal cache, memory 1104, or storage 1106. In particular embodiments, processor 1102 may include one or more internal caches for data, instructions, or addresses. This disclosure contemplates processor 1102 including any suitable number of any suitable internal caches, where appropriate. As an example and not by way of limitation, processor 1102 may include one or more instruction caches, one or more data caches, and one or more translation lookaside buffers (TLBs). Instructions in the instruction caches may be copies of instructions in memory 1104 or storage 1106, and the instruction caches may speed up retrieval of those instructions by processor 1102. Data in the data caches may be copies of data in memory 1104 or storage 1106 for instructions executing at processor 1102 to operate on; the results of previous instructions executed at processor 1102 for access by subsequent instructions executing at processor 1102 or for writing to memory 1104 or storage 1106; or other suitable data. The data caches may speed up read or write operations by processor 1102. The TLBs may speed up virtual-address translation for processor 1102. In particular embodiments, processor 1102 may include one or more internal registers for data, instructions, or addresses. This disclosure contemplates processor 1102 including any suitable number of any suitable internal registers, where appropriate. Where appropriate, processor 1102 may include one or more arithmetic logic units (ALUs); be a multi-core processor; or include one or more processors 1102. Although this disclosure describes and illustrates a particular processor, this disclosure contemplates any suitable processor.

In particular embodiments, memory 1104 includes main memory for storing instructions for processor 1102 to execute or data for processor 1102 to operate on. As an example and not by way of limitation, computer system 1100 may load instructions from storage 1106 or another source (such as, for example, another computer system 1100) to memory 1104. Processor 1102 may then load the instructions from memory 1104 to an internal register or internal cache. To execute the instructions, processor 1102 may retrieve the instructions from the internal register or internal cache and decode them. During or after execution of the instructions, processor 1102 may write one or more results (which may be intermediate or final results) to the internal register or internal cache. Processor 1102 may then write one or more of those results to memory 1104. In particular embodiments, processor 1102 executes only instructions in one or more internal registers or internal caches or in memory 1104 (as opposed to storage 1106 or elsewhere) and operates only on data in one or more internal registers or internal caches or in memory 1104 (as opposed to storage 1106 or elsewhere). One or more memory buses (which may each include an address bus and a data bus) may couple processor 1102 to memory 1104. Bus 1112 may include one or more memory buses, as described below. In particular embodiments, one or more memory management units (MMUs) reside between processor 1102 and memory 1104 and facilitate accesses to memory 1104 requested by processor 1102. In particular embodiments, memory 1104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1104 may include one or more memories 1104, where appropriate. Although this disclosure describes and illustrates particular memory, this disclosure contemplates any suitable memory.

In particular embodiments, storage 1106 includes mass storage for data or instructions. As an example and not by way of limitation, storage 1106 may include a hard disk drive (HDD), a floppy disk drive, flash memory, an optical disc, a magneto-optical disc, magnetic tape, or a Universal Serial Bus (USB) drive or a combination of two or more of these. Storage 1106 may include removable or non-removable (or fixed) media, where appropriate. Storage 1106 may be internal or external to computer system 1100, where appropriate. In particular embodiments, storage 1106 is non-volatile, solid-state memory. In particular embodiments, storage 1106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1106 taking any suitable physical form. Storage 1106 may include one or more storage control units facilitating communication between processor 1102 and storage 1106, where appropriate. Where appropriate, storage 1106 may include one or more storages 1106. Although this disclosure describes and illustrates particular storage, this disclosure contemplates any suitable storage.

In particular embodiments, I/O interface 1108 includes hardware, software, or both, providing one or more interfaces for communication between computer system 1100 and one or more I/O devices. Computer system 1100 may include one or more of these I/O devices, where appropriate. One or more of these I/O devices may enable communication between a person and computer system 1100. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1108 for them. Where appropriate, I/O interface 1108 may include one or more device or software drivers enabling processor 1102 to drive one or more of these I/O devices. I/O interface 1108 may include one or more I/O interfaces 1108, where appropriate. Although this disclosure describes and illustrates a particular I/O interface, this disclosure contemplates any suitable I/O interface.

In particular embodiments, communication interface 1110 includes hardware, software, or both providing one or more interfaces for communication (such as, for example, packet-based communication) between computer system 1100 and one or more other computer systems 1100 or one or more networks. As an example and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1110 for it. As an example and not by way of limitation, computer system 1100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1100 may include any suitable communication interface 1110 for any of these networks, where appropriate. Communication interface 1110 may include one or more communication interfaces 1110, where appropriate. Although this disclosure describes and illustrates a particular communication interface, this disclosure contemplates any suitable communication interface.

In particular embodiments, bus 1112 includes hardware, software, or both coupling components of computer system 1100 to each other. As an example and not by way of limitation, bus 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1112 may include one or more buses 1112, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising, by a computing system:
receiving one or more signals from one or more sensors associated with an artificial reality system;
determining one or more parameters associated a display content for the artificial reality system based on the one or more signals of the one or more sensors associated with the artificial reality system;
generating the display content based on the one or more parameters; and
outputting the display content to a display of the artificial reality system.

2. The method of claim 1, further comprising:
predicting a first head pose of a user of the artificial reality system in a three-dimensional (3D) space at a first time, the first time corresponding to when a first set of lines of a frame is to be output by the display of the artificial reality system;
determining a first visibility of one or more objects defined within the 3D space based on the first head pose of the user;
generating the first set of lines of the frame based on the determined first visibility of the one or more objects; and
outputting the first set of lines using the display of the artificial reality system.

3. The method of claim 2, further comprising:
predicting one or more second head poses of the user of the artificial reality system in the 3D space based on the first head pose and a predicted six degrees-of-freedom (6DoF) movement of the artificial reality system at one or more subsequent times to the first time, the one or more subsequent times respectively corresponding to when one or more second sets of lines of the frame are to be output by the display;
determining, based on the one or more second head poses, one or more second visibilities of the one or more objects defined within the 3D space;
generating the one or more second sets of lines of the frame using, respectively, the one or more second visibilities of the one or more objects; and
outputting, using the display of the artificial reality system, the one or more second sets of lines of the frame at the one or more subsequent times, respectively.

4. The method of claim 1, further comprising:
predicting a first head pose of a user of the artificial reality system in a three-dimensional (3D) space at a first time, the first time corresponding to when a first line of a first set of lines of a plurality of sets of lines of a frame is to be output by a display of the artificial reality system; and
determining a plurality of subframes that partition the frame, wherein each subframe comprises a set of lines of the plurality of sets of lines of the frame to be output by the display of the artificial reality system;
predicting a second head pose of the user of the artificial reality system in the three-dimensional (3D) space at a second time, the second time corresponding to when a final line of the first set of lines of the plurality of sets of lines of the frame is to be output by the display of the artificial reality system;
determining a first plurality of visibilities of one or more objects defined within the 3D space based on the first head pose and the second head pose;
generating the first set of lines of the frame based on the determined first plurality of visibilities of the one or more objects, wherein the first set of lines of the frame corresponds to a first subframe of the plurality of subframes; and
outputting the first set of lines using the display of the artificial reality system.

5. The method of claim 4, further comprising:
predicting a third head pose of the artificial reality system in the three-dimensional (3D) space at a third time, the third time corresponding to when a first line of a second set of lines of the plurality of sets of lines of the frame is to be output by the display of the artificial reality system;
predicting a fourth head pose of the artificial reality device in the three-dimensional (3D) space at a fourth time, the fourth time corresponding to when a final line of the second set of lines of the plurality of sets of lines of the frame is to be output by the display of the artificial reality system;
determining a second plurality of visibilities of the one or more objects defined within the 3D space based on the second head pose, the third head pose, and the fourth head pose.
generating the second set of lines of the frame based on the determined second plurality of visibilities of the one or more objects, wherein the second set of lines of the frame corresponds to the second subframe of the plurality of subframes; and
outputting the second set of lines using the display of the artificial reality system.

6. The method of claim 1, further comprising:
receiving one or more depth measurements of a real environment;
generating, based on the depth measurements, an occlusion surface representing one or more physical objects in the real environment as seen from a viewpoint of a user of an artificial reality environment, the occlusion surface comprising a plurality of texels;
generating a signed distance field (SDF) value for each of the plurality of texels, the SDF value of each texel representing a distance from that texel to a closest texel at which the one or more physical objects appear in the occlusion surface;
posing the occlusion surface in a three-dimensional space;
sampling the SDF values of the plurality of texels of the posed occlusion surface to generate an interpolated SDF value for each of a plurality of pixels;
generating, for each of the plurality of pixels, an alpha value based on the interpolated SDF value associated with the pixel; and
generating an output image based on the alpha values of the plurality of pixels.

7. The method of claim 1, further comprising:
selecting a plurality of tiled regions within the display for sampling;
measuring a brightness of each light-emitting element in the plurality of tiled regions;
determining a usage pattern of the display based on the measured brightness of the light-emitting elements in the plurality of tiled regions; and
adjusting, based on the usage pattern, an output image to compensate for degradations of the display.
